(19) United States
(12) Patent Application Publication
(10) Pub. No.: US 2010/0205631 A1
(43) Pub. Date: Aug. 12, 2010

(54) SCREEN TEXT MESSAGING

(76) Inventor: Rien Heald, Naperville, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/700,092

(22) Filed: Feb. 4, 2010

Related U.S. Application Data
(60) Provisional application No. 61/206,894, filed on Feb. 6, 2009.

(51) Int. Cl. H04N 7/025; H04W 4/12; H04N 9/31

(52) U.S. Cl. 725/34; 455/466; 348/744; 348/E09.025

(57) ABSTRACT

The invention provides a method and system for displaying user communicated messages in conjunction with a video viewable by members of a live audience which is gathered together in a single room. A video is displayed on a display screen viewable by the members of the live audience gathered together in a single room. User communicated messages are received from members of the live audience gathered together in the single room. The messages are then displayed onto the display screen viewable by the members of the live audience gathered together in a single room to provide a fun and interactive experience.

### PRIORITY CLAIM

This Application claims the benefit of U.S. Provisional Application 61/206,894 filed on Feb. 6, 2009.

### FIELD OF THE INVENTION

The present invention relates to entertainment services wherein live audiences can interact with each other by posting messages on a display screen for other members of the live audience to read.

### BACKGROUND OF THE INVENTION

While the internet, cable television, and other video rental services and home theater systems make it very easy and comfortable to watch movies from home, there is still the desire to watch certain movies in a theater with a large screen and a high quality sound system or to simply watch them in the company of others.

For certain movies, there is a desire to have the audience remain quiet for all to enjoy the movie. Talking can be very disruptive during certain intense or romantic scenes or when the dialogue is very detailed.

There are other movies, such as the Rocky Horror Picture Show, that have gained a cult-like status where audience members frequently participate in activities in concert with the movie such as singing and dancing in the aisles along with the actors on the screen and reciting lines spoken by the actors. For these movies, the interaction among the audience is what makes the movie theater experience especially entertaining. However, the noise can be very distracting for those members of the live audience trying to watch the movie.

With almost every movie, something takes place that causes one viewer to comment to another viewer about the movie such as a bad line in the script. This noise also can be distracting to those sitting nearby trying to watch the movie.

The use of cell phones and personal digital assistants having the ability to send and receive text messages has become very common. Frequently, movie audience members will communicate to each other via text messages during a movie sharing comments about the movie. A member of the audience may send a text message to a friend that he believes is very entertaining and that he wishes he could share with more members of the audience.

This present invention addresses the situation where members of the live audience want to share their comments with many others in the live audience but to do so in a quiet manner so as to not disrupt the big screen movie experience for others trying to quietly watch the movie.

### BRIEF SUMMARY OF THE INVENTION

In one embodiment, the present invention provides a method of displaying user communicated messages in concert with a video viewable by members of a live audience gathered together in a single room. The method comprises displaying the video on a display screen viewable by the members of the live audience. User communicated messages are received from members of the live audience. The messages are displayed onto the display screen viewable by the members of the live audience. The video may be displayed at a first predetermined location and the messages may be displayed at a second predetermined location that is different than the first predetermined location so the messages do not interfere with the video.

The invention may also include filtering the messages to maintain a particular level of dialogue appropriate for the audience.

In another embodiment of the present invention, a system is provided for displaying user communicated messages in conjunction with a video viewable by members of a live audience which is gathered together in a single room. The system includes a computer having a processor for receiving user communicated messages from the live audience and for combining the user communicated messages and the video on the same screen viewable by the live audience.

Similarly, the system may include means for filtering the content of the user communicated messages to keep the dialogue appropriate for the particular audience.

### BRIEF DESCRIPTION OF THE DRAWINGS

FIG. 1 is a schematic of the system of the present invention;

FIG. 2 is a view of the display screen depicting a video, electronically communicated messages, and additional information;

FIG. 3 is a flow chart depicting the method of the present invention;

FIG. 4 is a is a flow chart depicting how several processes of the present invention work together;

FIG. 5 is a flow chart of the Process Messages process of the present invention;

FIG. 6 is a flow chart of the Process Script process of the present invention; and

FIG. 7 is a flow chart of the Show Messages process of the present invention.

### DETAILED DESCRIPTION OF THE INVENTION

Detailed embodiments of the present invention are disclosed herein; however, it is to be understood that the disclosed embodiments are merely exemplary of the invention that may be embodied in various and alternative forms.

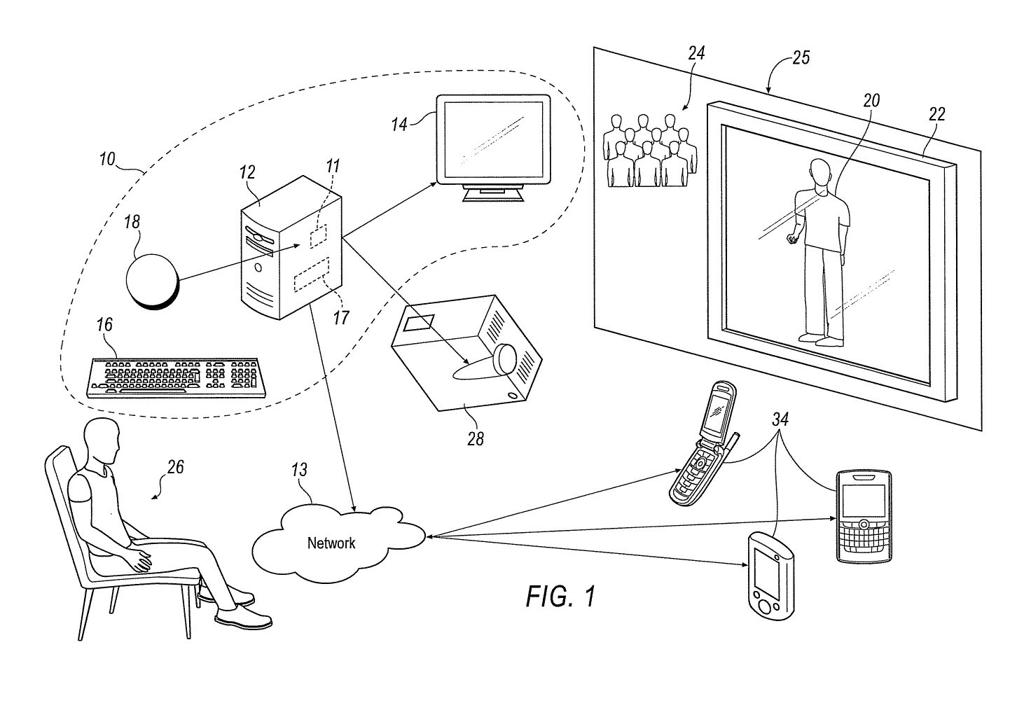

As shown in FIG. 1, the system 10 includes a computer 12 having a processor 11 connected to the World Wide Web or internet 13 to receive information as is well known in the art. The requirements for the current computer system are that the computer 12 can seamlessly play a DVD while running the necessary software and being connected to the internet 13. As is typical, the computer 12 includes at least one monitor 14, a keyboard 16, and internal hard drive 17, and a movie source 18 such as, but not limited to a Blu-ray, DVD or CD player, a hard drive, a memory stick, or other electronic storage media. The computer may be a stand alone “desk top” style or a lap top.

The computer 12 is loaded with the MuVChat software which performs as detailed below. In summary, the software allows a movie to be displayed on the same screen as messages communicated by members of a live audience 24. In the preferred embodiment, the software is written in visual c#.net but any other available programming language can easily be substituted.

The system 10 sends an image or video 20 to a display screen 22 to be seen by the live audience 24 and/or to the computer monitor 14 viewable by a system administrator 26. To display the video 20 to the live audience 24 a common projector 28 may be connected to the computer 12 as is well known in the art to display the video 20 to a display screen 22 to be viewed by the live audience 24 gathered in the same room 25.

Alternatively, the display screen 22 viewed by the live audience 24 can be a large CRT, television, or other electronic display device or devices connected to the computer 12 using common and well known video outputs from the computer to the display screen 22 such as, but not limited to, HDMI or RFG. Other means of providing the image or video 20 to be viewed by the live audience 24 are also possible.

Setting up the system 10 to run requires certain steps outlined below. However, the steps do not necessarily have to be preformed in the order described.

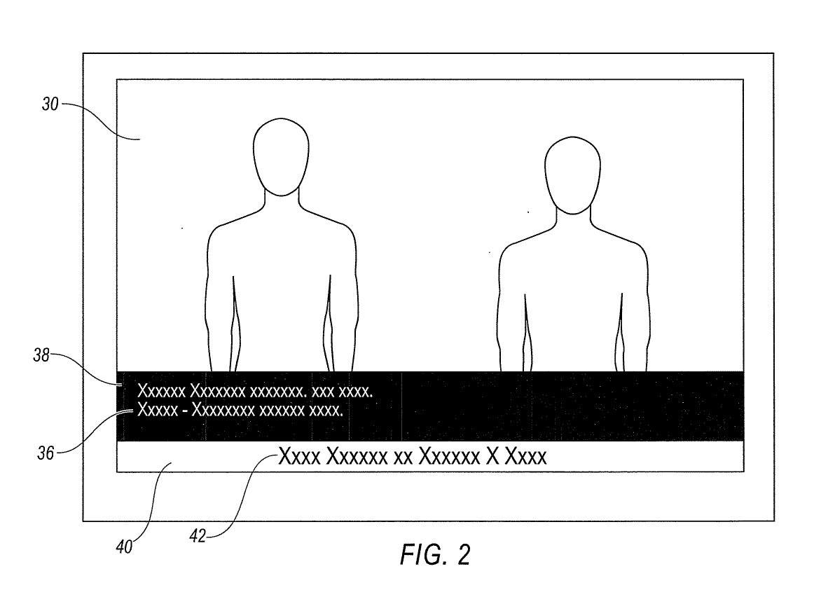

To set up the system 10 to display the images or video 20 and the user communicated messages 36, the system administrator 26 selects the movie to be played from the video source 18 using known methods. The movie can be displayed on either or both the computer monitor 14 and the display screen 22 during the set up process. The movie may be displayed at a first predetermined position 30 on the display screen 22 as shown in FIG. 2.

Many options are available with the current software to optimize the system 10. Some of the options are described below.

The current software may have a control panel having multiple tabs with various options. In this section, the system administrator 26 can enter system administrator communicated text 32 to be displayed along with the user communicated messages 36 from the live audience 24 as part of the queue or immediately if desired. The system administrator communicated text 32 may be displayed in a second predetermined location 38 on the display screen 22 different than the first predetermined location 30. Using known database or programming techniques, a log of the user communicated messages 36 can be created and stored.

All messages (system administrator communicated text 32 and user communicated messages) in the queue may be displayed in a message queue accessible by the system administrator 26. The system administrator 26 can select messages and move them up or down in the queue or remove them from the queue for any reason.

The system 10 and software allow for predetermined system administrator communicated text 32 to appear at predetermined times throughout the video presentation in the second predetermined location 38.

The system 10 and software allow the system administrator 26 to configure how all text looks on the screen including, but not limited to, the font, color, size, back ground color, the speed at which messages appear and stay on the display screen 22. The system 10 and software is configurable to make all the displayed text visually appealing depending on the particular movie and theater conditions.

The system administrator 26 can also control if any slides are displayed at anytime before during or after the movie presentation. The slides can be in almost any format such as, but not limited to jpeg, HTML, or gif. Such slides can, for example, introduce MuVChat, provide instructions, advertise, provide pre-show entertainment, or simply show pictures of popcorn to entice the audience to purchase food products. The slide presentation information can be stored and replayed later without the need to reprogram the information.

Information about the live audience members 24, such as the phone numbers or number of messages sent, can be stored for later retrieval if desired or necessary. Should a member of the live audience 24 not abide by the rules of the movie theater, the particular member can have his privileges to post user communicated messages 36 suspended or terminated.

As shown in FIG. 2, the system administrator 26 may also program other text or information 42 to appear at a third predetermined location 40 which may be different than the first or second predetermined locations 30, 38 so as to not interfere with the other user communicated messages 36 displayed on the display screen 22. This text or information 42 may include advertisements, announcements, or other types of messages and may appear throughout the movie showing or sporadically.

Once the system is set up to meet the requirements of the system administrator 26 for the particular viewing, the set up can be saved and retrieved for another showing.

The user communicated messages 36 can be filtered to control the words displayed on the screen using known filtering techniques. For example, certain inappropriate or offensive words can be prevented from displaying on the display screen. Alternatively, whole comments can be prevented from being displayed on the display screen. Further, only certain letters may be edited such that the complete word is not available, but the gist of the word is still there.

The amount of filtering is adjustable by the system administrator. For movies with a “mature audiences” or MA rating, the filtering may be minimal. However, for PG-13 or G showings or for other particular audiences, the filtering may be more extensive.

The system 10 receives the user communicated messages 36 through the internet 13 as is well known in the art. As described below, the software processes the incoming user communicated messages 36 and then may display these messages in a second predetermined location 38 on the screen different than the first predetermined location so as to not interfere with the movie.

To allow the live audience 24 to send user communicated messages 36, the members of the live audience 24 must send a keyword to the appropriate phone number or email address set up by the system administrator 26 or otherwise register their cell phones, personal digital assistants, or other electronic communication devices (collectively) 34 that are capable of sending user communicated messages 36 via short message service (SMS), multimedia messaging service (MMS), radio frequency communications, or similar methods. The electronic communication devices 34 are currently configured such that they contain a keyboard to enter text and a display screen to view what is entered or received from the system administrator. Other forms of entering the information such as speech recognition are also within the scope of this invention. Currently, the system is configured to accept alphanumeric messages, but may be adapted to include other for iris of communication. The particular form of the electronic communication is not important, only the fact that the user communicated message 36 can easily be sent by members of the live audience 24 to the system 10.

The keyword is set up by the system administrator 26 and may be unique for each movie showing to prevent previous audience members from writing to different movie showings.

The registering member of the live audience 24 may get a welcome response from the system 10. At that point, all user communicated messages 36 will be sent to the system 10 for processing. A nickname may be required to be provided by the member of the live audience 24 for identification. This nickname will be included in the user communicated messages 36 displayed on the display screen 22.

The user communicated messages 36 may say, for example, “someone get me popcorn” or some witty comment about the movie as illustrated in FIG. 2.

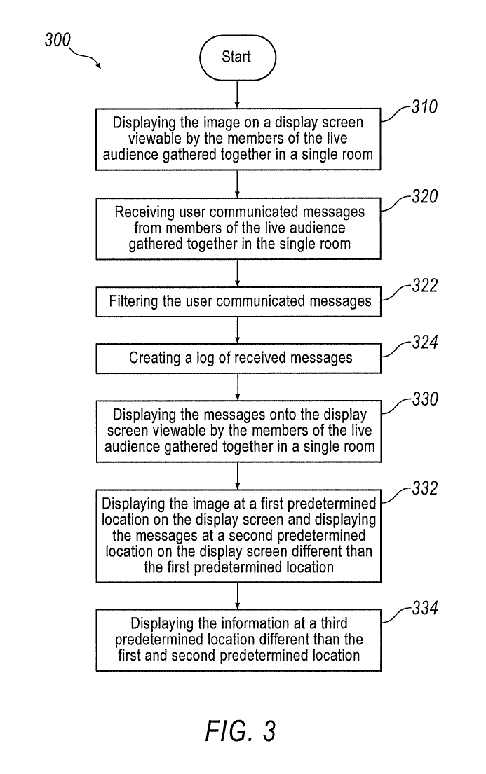

In FIG. 3, a high level flow chart illustrating the present invention is depicted. In step 310, an image or video 20 is projected onto a display screen 22 viewable by the members of the live audience 24 gathered together in a single room 25 suing the system described above. In step 320, user communicated messages 36 are received from members of the live audience 24 gathered together in the single room 25. And in step 340, the messages are displayed onto the display screen 22 viewable by the members of the live audience 24 gathered together in a single room 25.

Some additional steps that add further features are also depicted in the high level flow chart depicted in FIG. 3. For example, step 322 comprising filtering the user communicated messages 36 before displaying them on the display screen 22. The filtering operation helps maintain the proper dialogue for the viewing audience. Another optional process shown as step 324 is to create a log of the received user communicated messages 36 so that the system administrator 26 can monitor, for example, who is posting and what they are posting. To make the viewing experience more pleasurable and without overriding the video image, optional step 322 includes displaying the image or video 20 at a first predetermined location 30 on the display screen 22 and displaying the user communicated messages 36 at a second predetermined location 38 on the display screen 22 different than the first predetermined location 30. Yet another optional step shown in step 334 is displaying information 42 at a third predetermined location 40 different than the first and second predetermined locations 30, 38.

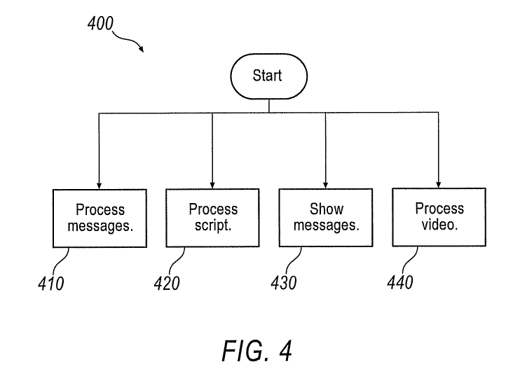

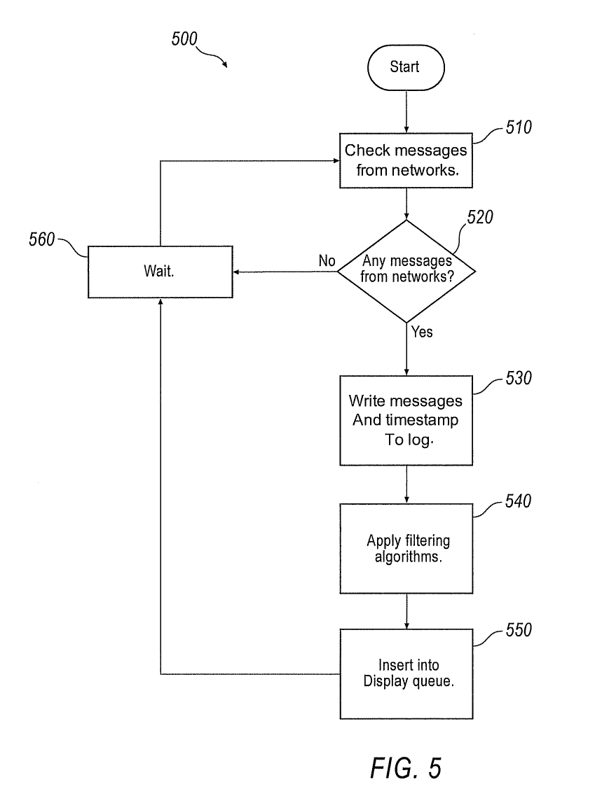

Another high level flow chart showing how the software works is depicted in FIG. 4. In FIG. 4, the system starts and 4 sub processes depicted as Process Messages 410, Process Script 420, Show Messages 430, and Process Video 440 are illustrated. Sub processes Process Messages 410, Process Script 420, Show Messages 430 are described in more detail in FIGS. 5, 6, and 7 below. Sub process 440 is any well known video processing technique.

In the following paragraphs, the term messages may include (1) user communicated messages 36, (2) system administrator communicated messages 26, or (3) both types of messages since both messages may be processed.

FIG. 5 depicts one possible Process Messages flow chart. In the first step 510, the system checks to see if there messages. In step 520, if there are messages, the system time stamps and records information into a log. As described above, filtering algorithms are applied in step 540 to maintain the proper level of dialogue. Messages are then inserted in a display queue in step 540. The process then repeats itself through step 560 back to step 510. If there are no messages when the system checks in step 520, the system will repeat step 510 through step 560.

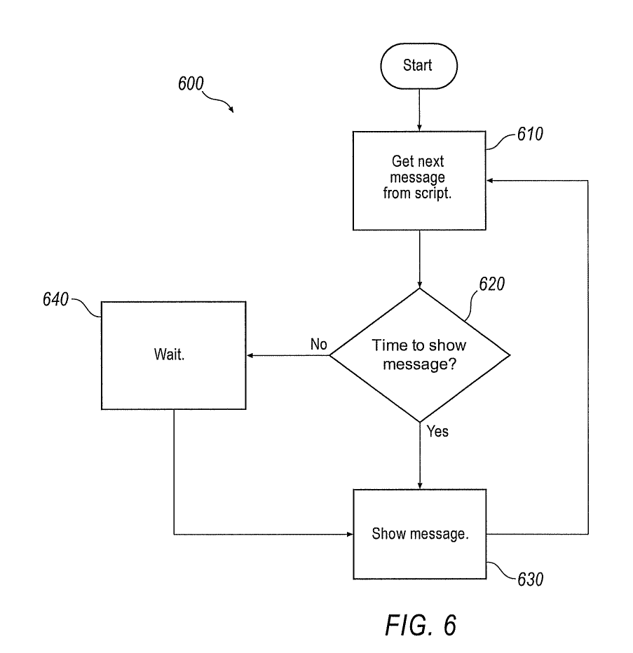

A flowchart for the processing of Processing Scripts is depicted in FIG. 6. In step 600, the process script is started. In step 610, the first message from the script is retrieved. The next step 620 determines if it is time to show the message based on timing information entered by the system administrator 26. If it is not time yet, the message is not displayed and the system waits the necessary amount of time as shown in step 640. Once it is time, the message is displayed as shown in step 630 and the process goes back to step 620 to retrieve the next message. If in step 620, it is time to display the next message, the message is shown as in step 630.

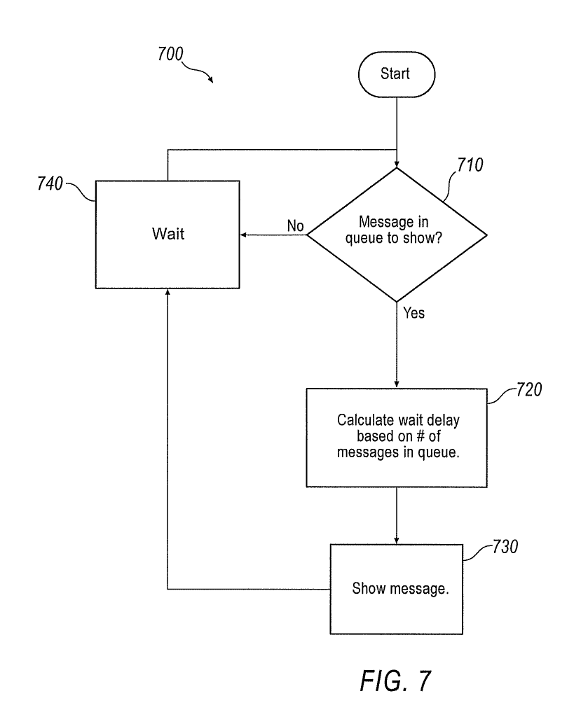

A flow chart depicting the show messages flow process is shown in FIG. 7. The process is started in step 700. The system looks in step 710 for a message in the queue. If there is no message, the system waits in step 740 and then starts over in step 710. If there is a message, the system calculates the wait time before the message is displayed based on the number of messages in the queue in step 720. When it is time to show the message, the message is shown in step 730.

Lastly, the video 20 and the messages are projected or shown on the display screen 22 at the appropriate time using well known techniques.

Although specific embodiments and examples of the invention have been described for illustrative purposes, various equivalent modifications can be made without departing from the spirit and scope of the invention, as will be recognized by those skilled in the art after reviewing this patent disclosure.

In general, the following claims should not be construed to limit the invention to the specific embodiments disclosed in the specification.

What is claimed as new and desired to be protected by Letters Patent of the United States is:

1. A method of displaying user communicated messages in conjunction with a video viewable by members of a live audience which is gathered together in a single room, the method comprising:
displaying the video on a display screen viewable by the members of the live audience gathered together in a single room;
receiving user communicated user messages from members of the live audience gathered together in the single room; and
displaying the user communicated messages onto the display screen viewable by the members of the live audience gathered together in a single room.

2. The method of claim 1 further comprising displaying the video at a first predetermined location on the display screen and displaying the user communicated messages at a second predetermined location on the display screen different than the first predetermined location.

3. The method of claim 1 wherein the user communicated messages are received from users using SMS technology.

4. The method of claim 1 wherein the user communicated messages are received from users using MMS technology.

5. The method of claim 1 further comprising creating a log of at least the received user communicated messages.

6. The method of claim 1 further comprising displaying predetermined messages onto the display screen.

7. The method of claim 1 further comprising receiving the user communicated user messages from member of the live audience through mobile communication means.

8. The method of claim 1 further comprising filtering the user communicated user messages.

9. The method of claim 1 further comprising displaying user communicated messages on the display screen entered by a system administrator.

10. The method of claim 2 further comprising displaying information at a third predetermined location different than the first and second predetermined locations.

11. The method of claim 1 further comprising retrieving the video from a video source.

12. The method of claim 1 further comprising connecting to a network to receive the user communicated messages from users.

13. A system for displaying user communicated messages in conjunction with a video viewable by a live audience, the system comprising:
a device for displaying the video on a display screen viewable by the live audience;
means for receiving user communicated messages; and
means for combing the user communicated messages and the image on the same screen viewable by the live audience.

14. The system of claim 13 further comprising means for displaying predetermined messages onto the display screen.

15. The system of claim 13 further comprising means for filtering the user communicated messages.

16. The system of claim 13 wherein the device for displaying the video is a projector.

17. The system of claim 13 wherein the video is displayed at a first predetermined location and the user communicated messages are displayed at a second predetermined location different than the first predetermined location.

18. The system of claim 17 further comprising means for displaying information at a third predetermined location different than the first and second predetermined locations.

19. A system for displaying user communicated messages in conjunction with a video displayed on a display screen viewable by a live audience, the system comprising:
a processor for receiving user communicated messages from the live audience; and
a processor for combining the user communicated messages and the video such that the user communicated messages and the video are capable of being displayed on the same screen viewable by the live audience.

20. The system of claim 19 further wherein the processor filters the user communicated messages.

22. The system of claim 19 wherein the video is displayed at a first predetermined location and the user communicated messages are displayed at a second predetermined location different than the first predetermined location.

23. The system of claim 22 wherein information is displayed at a third predetermined location different than the first and second predetermined locations.

24. The system of claim 19 further comprising a projector for displaying the video on the same screen viewable by the live audience
